(19) United States
(12) Patent Application Publication
(10) Pub. No.: US 2008/0172698 A1
(43) Pub. Date: Jul. 17, 2008

(54) Performing support functions on a portable device

(76) Inventors: Adam L. Berger, Pittsburgh, PA (US); Gregory C. Schohn, Brooklyn, NY (US)

Correspondence Address: FISH & RICHARDSON PC, P.O. BOX 1022, MINNEAPOLIS, MN, 55440-1022, US

(21) Appl. No.: 11/652,918

(22) Filed: Jan. 12, 2007

(51) Int. Cl. G06F 13/00

(52) U.S. Cl. 725/50

(57) ABSTRACT

Among other things, on a portable device on which one or more AV items received from an external source are performed for a user during performance periods, at least one support function other than performing AV items, including receiving schedule information related to AV items, is performed in a background mode.

### BACKGROUND

This description relates to performing support functions on a portable device.

Some portable devices, such as mobile phones, personal digital assistants (PDAs), laptops, and portable navigation devices, are capable of presenting audio or video items, such as television programs or audio tracks, to users. We refer to such audio and video (AV) capable devices as AV-on-portable-devices (AVopd's). AVopd's typically use a foreground model in which the user decides when to launch an AV presentation application that will present the AV item or items to the user. While the AV item is being viewed, the AV presentation application is running in the foreground on the AVopd. When the user is done experiencing the item or items, he exits the AV presentation application.

The states of such an AV presentation application can be that it is (a) running in the foreground on the AVopd and either (i) actively presenting an AV item (e.g., a live TV program) or (ii) not actively presenting an AV item (in which case it could be showing a menu of channels or a service guide while waiting for user input or downloading data, e.g., a schedule guide or a media clip), or (b) off, that is, not running at all.

### SUMMARY

In general, in an aspect, on a portable device on which one or more AV items received from an external source are performed for a user during performance periods, support functions other than performing AV items, including receiving schedule information related to AV items, are performed in a background mode. (By a background mode, we mean to include a mode in which there is no active console for the application, for example, the display of the device does not show the AV support application in the foreground, nor is the user able to directly interact with the application, even though the application is still running and can be brought back to the foreground by explicit user action.)

Implementations may include one or more of the following features. The support function includes receiving AV items from an external source. The support function includes receiving the schedule information from an external source. At least one of the support functions is executed without intervention by a user. The aspects of the execution of the support function are specified by a user. The support function is performed beginning automatically when the portable device is initialized. The support function continues to be performed automatically as long as the portable device is powered. The execution of at least one of the support functions is dependent on a power state of the portable device. The power state comprises information about battery life. The execution of at least one of the support functions is dependent on a communication state of the portable device. The user is alerted if the communication state affects the execution of a support function. The support function is executed without knowledge of the user. The user can specify a schedule or conditions for execution of at least one of the support functions. The user is notified when a support function cannot be performed.

In general, in an aspect, on a portable video-capable device, AV items are performed that have been received from an external source. In a background mode, schedules are received of other AV items that will be available at specified times.

These and other aspects and features, and combinations of them, may be expressed as methods, apparatus, systems, means for performing functions, and program products, and in other ways.

Advantages may include one or more of the following. Battery life is conserved for use by the possibly more important communication function, such as cell phone calling or navigation. The AVopd can continually perform background function like those performed by stationary cable, satellite, and Internet-protocol television (IPTV) digital set top boxes (DSTBs), including (a) updating a display of upcoming programming by channel based on schedule information received from a broadcast stream, (b) monitoring the upcoming schedule and recording shows that match a user's preset policy (e.g., record every Seinfeld episode), (c) acquiring needed licenses for incoming programming, (d) reporting data (e.g., usage) back to a central repository, and (e) installing software updates.

Other advantages and features will become apparent from the following description and from the claims.

### DESCRIPTION

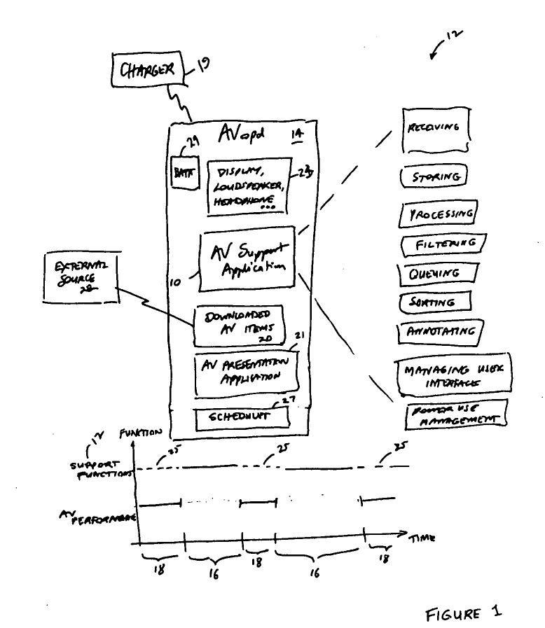

FIG. 1 is a block diagram.

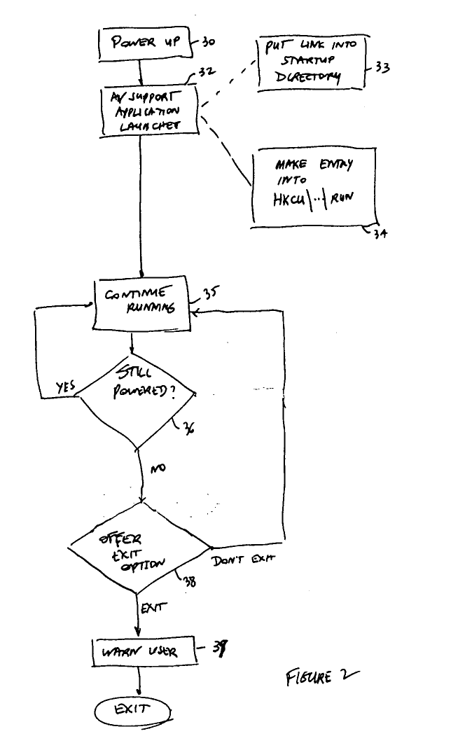

FIGS. 2, 4, and 5 are flow charts.

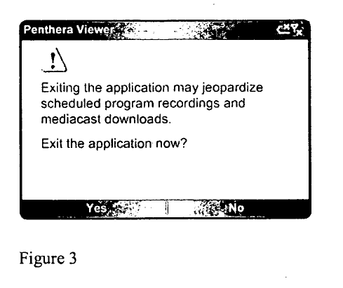

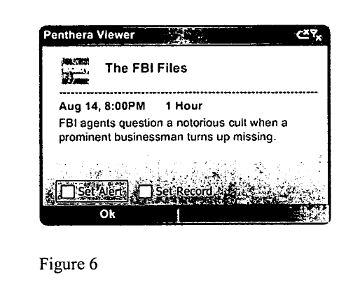

FIGS. 3 and 6 are screen shots.

As shown in FIG. 1, an AV support application 10 can be arranged to execute support functions 12 on an AVopd 14 during support periods 16 as background tasks, that is, in a manner that does not involve interaction of (or typically awareness by) the user. The support functions can be performed in the background during support periods other than during the performance periods 18 when one or more AV items 20 received from an external source 22 are being performed for the user by an AV presentation application 21 on a display, loudspeaker, headphone, or other output device 23. As indicated by the dashed lines 25, in some implementations, the support functions are also executed in the background during the performance periods. The AV support application can be running in the background during periods when it is not performing any support functions, but is idling.

The support functions can include a wide variety of functions with respect to AV items, including (but not limited to) receiving, storing, processing, filtering, queuing, sorting, and annotating the AV items and schedules 27 (also received from an external source) indicating when the AV items will be available.

For example, the support functions could include (a) downloading schedule information and downloading AV items of interest at times when they are available for download, (b) obtaining and managing rights to perform AV items on the portable device under digital rights management (DRM) systems and conditional access systems (CAS), (c) receiving, storing, and analyzing information about the use of battery power by the portable device and taking actions with respect to one or more of the support functions based on the information, (d) maintaining and running a user interface to enable a user to configure and control all of the operations of the AV support application. In various implementations, the AV support application may or may not have a user interface, and if one is provided, the complexity and detail of options exposed to the user can vary widely.

The external source can be any device or system or supplier or carrier capable of delivering audio or video material or schedule information or any other information useful to the functions performed by the AV support application to the AVopd at any time and through any medium, including wired and wireless (radio frequency, light, infrared and other) communication links.

The operations of the external source and the AV support application on the AVopd can be coordinated so that information other than the AV items or schedules can be communicated back and forth between them and used at either end or cooperatively to aid in performing the AV support application. For example, supplemental information describing or otherwise associated with AV items may be delivered to the AVopd, and the AVopd can send to the external source (or to other devices and locations) information about the use or status of the AV support application, the state of its power source, and other data.

The AV support application can be configured, for example, when the application is designed and manufactured, or through a user interface when the application is to be used or is in use. Depending on the implementation, none, some, or all of the functions performed by the AV support application can be configured by the user. For example, as shown in FIG. 6, a user can be asked whether to set an alert or set for recording with respect to a particular AV item described on a displayed screen. The AVopd may include a wide variety of other hardware and software (e.g., an operating system) to perform a wide variety of functions not shown in FIG. 1. None, some, or all of the support functions provided by the support application may be performed continually or at recurring, scheduled times, without requiring user intervention or a user request. In some implementations, none, some, or all of the support functions may also be provided in a foreground mode in response to a user's request.

As shown in FIG. 2, in some implementations, the AV support application launches automatically 32 when the device powers up 30. On devices that run a Microsoft Windows Mobile operating system, for example, this can be done by putting a link into the application in the \Windows\Startup directory 33. On devices that run Windows XP, an entry can be made 34 into HKCU\Software\Microsoft\Windows\CurrentVersion\Run.

Once launched the AV support application generally continues to run indefinitely 35 as long as the device is powered 36. The user interface may offer either no explicit exit menu function for the application (that is, the user cannot terminate the AV support application) or an exit option 38 with a warning 39 to the user about the effects of exiting, as illustrated in FIG. 3.

The power use management function of the AP support application will control the operation of the AP support application to influence charge conservation of the battery 29 in a manner that is consistent either with rules. The rules may be set in the design and manufacture of the AVopd or set by the user, for example, through the user interface also managed as one of the AV support application functions.

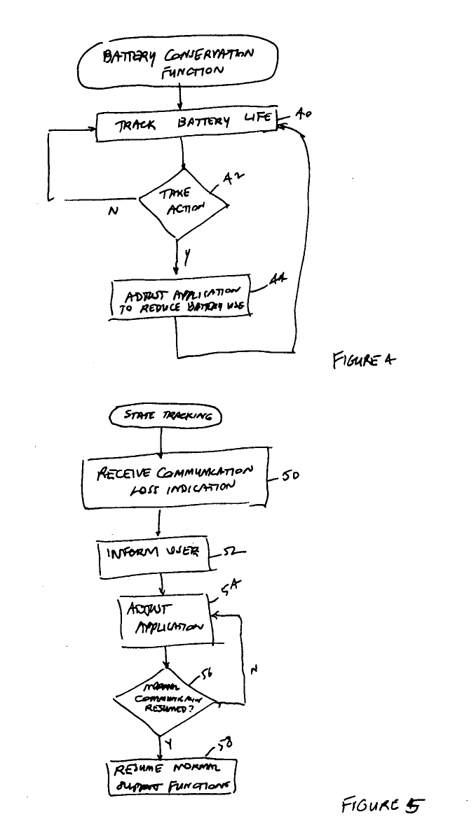

As shown in FIG. 4, the battery conservation function tracks the charge state of the battery 40 using information available from hardware and software running on the AVopd. The information could include the current charge level, the historical charge level, the rate of discharge, the estimated time of discharge, and any other data that is available and indicative of whether and to what extent the operation of the AP support application should be reduced or stopped. The AV support application may include or have access to threshold values against which to compare the actual charge state and charge history information to determine whether it is time to take action 42. If not, the process simply continues to track battery life.

Otherwise the battery conservation process takes appropriate action 44, for example, by altering one or more of the extent, number, frequency, intensity, and identity of the AV support application functions that are being performed or will be performed in the future. In a extreme case, the AV support application may terminate all functions and shut down, or become idle for a period of time with a request to the operating system of the AVopd to wake it up later.

For example, the application could track when the battery life is near an end and temporarily shutdown the one or more functions to conserve battery power. The choice of which functions to shut down and under what conditions could be specified by the user in a setup menu. When the condition occurs and the function is shut down, the application may or may not alert the user depending on the settings.

The user may be offered optional power-saving choices, including shutting down the AV support application (a) never, (b) when the AVopd is disconnected from a charger 19 (AC power), (c) when remaining battery charge dips below some percentage, (d) when estimated-time-remaining-in-battery dips below a pre-specified time period; and/or (d) when the application has no scheduled activity for an upcoming pre-specified period.

The AV support application may also enable the user to specify power-saving and other settings and options 42 separately or in groups with respect to each of background functions and features that the application can perform. For example, the user could specify how often, when, and in what mode the AVopd would download schedule information, AV item information, and the AV items themselves. The user could set rules and policies concerning the program items to be downloaded based on title, subject, genre, age, length, source, cost, and other criteria, all as specified through the user interface. The user also could specify whether and how long to store incoming schedules, AV items, and other information, the manner and times to process the incoming or stored schedules, items, or other information.

In some examples, the AV support application may track the current state of the device (and the historical states) and perform actions based on the current and historical states. One aspect of the current state that can be tracked is when communication between the AVopd and external sources has been lost or degraded. For example, as shown in FIG. 5, other hardware or software running on the AVopd can inform the AV support application 50 when the AVopd has moved out of range of wireless communication and therefore may not be able to perform expected background functions. In some implementations, the AVopd would inform the user 52 (by an audible or visible alarm) that an expected schedule update or recording of a live stream of some other function cannot be performed because communication has been lost. In some examples, if the wireless connection is degraded but not lost, the support functions could be reduced in intensity or frequency, and some but not all could be terminated temporarily. In any case, the AVopd would adjust the application 54 to reduce or terminate any functions that cannot be performed during the communication outage. The AV support application would then watch for resumption of normal communication 56 and resume normal support functions when that is warranted.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment.

Method steps of the techniques described herein can be performed by one or more programmable processors executing a computer program to perform functions by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. Generally, a computer will include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Other implementations are within the scope of the following claims. The techniques could apply to and the phrase AV items is meant to include any television or radio items or any other video or audio material, for example, ring tones, as well as software applications, and any other programs, processes, information, or content that the AVopd may need or be capable of using and which can be downloaded and processed in the background with respect to the operation of the AVopd. Background functions include functions that can be conducted at least partly without disturbing or requiring action by the user of the device and sometimes without the user being aware that they are occurring.

1. A method comprising
on a portable device on which one or more AV items received from an external source are performed for a user during performance periods, executing at least one support function other than performing AV items for the user, the support function including receiving schedule information related to AV items, the support function being executed in a background mode.

2. The method of claim 1 in which the support function includes receiving AV items from an external source.

3. The method of claim 1 in which the support function includes receiving the schedule information from an external source.

4. The method of claim 1 in which at least one of the support functions is executed without intervention by a user.

5. The method of claim 1 in which aspects of the execution of the support function are specified by a user.

6. The method of claim 1 in which the support function is performed beginning automatically when the portable device is initialized.

7. The method of claim 1 in which the support function continues to be performed automatically as long as the portable device is powered.

8. The method of claim 1 in which execution of at least one of the support functions is dependent on a power state of the portable device.

9. The method of claim 8 in which the power state comprises information about battery life.

10. The method of claim 1 in which execution of at least one of the support functions is dependent on a communication state of the portable device.

11. The method of claim 10 in which the user is alerted if the communication state affects the execution of a support function.

12. The method of claim 1 in which the support function is executed without knowledge of the user.

13. The method of claim 1 also enabling the user to specify a schedule or conditions for execution of at least one of the support function.

14. The method of claim 1 also including notifying the user when a support function cannot be performed.

15. The method of claim 1 in which the user is not enabled to terminate the performance of the support function in the background mode.

16. The method of claim 1 in which the support function is performed by an AV support application that runs at times when none of the support functions is being executed.

17. A method comprising
on a portable video-capable device, performing AV items that have been received from an external esource, and
in a background mode, receiving schedules of other AV items that will be available at specified times.

18. The method of claim 17 also including receiving the AV items at the specified times.

19. The method of claim 18 in which aspects of the receiving of the AV items are specified by a user.

20. The method of claim 18 in which the receiving is performed beginning automatically when the portable device is initialized.

21. The method of claim 18 in which receiving continues to be performed automatically as long as the portable device is powered.

22. The method of claim 18 in which the receiving is dependent on a power state of the portable device.

23. The method of claim 18 in which the power state comprises information about battery life.

24. The method of claim 18 in which the receiving is dependent on a communication state of the portable device.

25. The method of claim 24 in which the user is alerted if the communication state affects the receiving.

26. The method of claim 18 including notifying the user when a support function cannot be performed.
